(19) United States
(12) Patent Application Publication
(10) Pub. No.: US 2014/0353029 A1
(43) Pub. Date: Dec. 4, 2014

(54) HARNESS

(71) Applicant: Toshiyasu Tsubouchi, Yokkaichi (JP)

(72) Inventor: Toshiyasu Tsubouchi, Yokkaichi (JP)

(73) Assignees: AUTONETWORKS TECHNOLOGIES, LTD., Yokkaichi, Mie (JP); SUMITOMO ELECTRIC INDUSTRIES, LTD., Osaka-shi, Osaka (JP); SUMITOMO WIRING SYSTEMS, LTD., Yokkaichi, Mie (JP)

(21) Appl. No.: 14/345,482

(22) PCT Filed: Sep. 6, 2012
(86) PCT No.: PCT/JP2012/072671

§ 371 Date: Mar. 18, 2014

(30) Foreign Application Priority Data
Sep. 21, 2011 (JP) 2011-206439

(51) Int. Cl. H01B 7/00; H01B 11/06

(52) U.S. Cl. CPC H01B 7/0045; H01B 11/06
USPC 174/72 A

(57) ABSTRACT

A harness including a twisted wire pair that can reduce noise and has an excellent assembly performance is provided. A harness includes a connector and two twisted wire pairs in which terminals for connection to the connector are crimped to the end portions. The twisted wire pairs are untwisted from the end portions so as to be easily connected to the connector. By connecting electric wires and electric wires to upper and lower terminal housing chambers on the respective outer sides of the connector, the spacing between neighboring terminals among the two twisted wire pairs is larger than the spacing between the terminals of the individual two twisted wire pairs.

This application claims priority to JP 2011-206439 filed in Japan on Sep. 21, 2011, the entire disclosure of which is hereby incorporated by reference in its entirety.

### TECHNICAL FIELD

Preferred embodiments of this disclosure relate to a harness including twisted wire pairs used between communication devices and the like.

### BACKGROUND

As the performance and functions of a vehicle are improved, a plurality of ECUs (Electronic Control Units) for controlling various electronic devices are mounted in a vehicle. Although a twisted wire pair obtained by twisting a pair of electric wires together is used for communication between ECUs and between the outside of a vehicle and an ECU in order to reduce the superimposition of noise on a communication signal, the electric wires need to be untwisted at a portion connected to a connector and various ideas have been introduced to solve the problem caused by this untwisting.

Patent Document 1 describes a harness in which a twisted wire pair obtained by twisting two signal wires together is connected to a terminal and the terminal is insulated with a dielectric substance, is covered with an external conductor shell, and is locked to the inside of the connector. The harness described in Patent Document 1 has a configuration in which the end portions of the electric wires are untwisted to loosen the twist and are connected to the terminal, and the entire untwisted portion is covered with the external conductor shell and is housed in the connector when the electric wires of the twisted wire pair are connected to the terminal. With this configuration, also in the untwisted portion in which the specific shielding performance of the twisted wire pair is lost, the occurrence of noise caused by electromagnetic waves is suppressed by the external conductor shell as in the twisted portion.

Patent Document 2 describes a harness provided with an electric wire holding member for allowing the two electric wires to be close to each other and holding them linearly in a portion exposed to the outside of the connector in the untwisted end portion of the twisted wire pair. Although an impedance is high in the untwisted portion, by providing the electric wire holding member for allowing the two electric wires to be close to each other and holding them, the impedance is suppressed so as to be low to be matched, so that the occurrence of noise caused by reflection can be suppressed.

### RELATED ART

Patent Document 1: JP 2004-063360A

Patent Document 2: JP 2004-071404A

### SUMMARY

### Technical Problem

Because assembly man-hours for housing the components such as a dielectric substance and an external conductor shell in the connector and connecting them increase, the assembly of the harness of Patent Document 1 is time consuming and laborious.

Moreover, since the harness of Patent Document 2 is provided with the electric wire holding member outside the connector, the twisted wire pair is routed from the end portion of the electric wire holding member, and therefore, routing options for the harness are limited.

Embodiments of the present disclosure were made in view of these circumstances, and it is an object thereof that a harness including a twisted wire pair that can reduce noise and has an excellent assembly performance is provided.

### Solution to Problem

In embodiments, a harness includes a connector and two twisted wire pairs in which terminals for connection to the connector are crimped to end portions of the wires, the harness being formed by connecting the terminals to the connector, wherein a spacing between neighboring terminals among the two twisted wire pairs is larger than a spacing between the terminals of the individual two twisted wire pairs.

Because the harness is formed by connecting the terminals, which are crimped to the end portions of the two twisted wire pairs, to the connector and the spacing between neighboring terminals among the two twisted wire pairs is larger than the spacing between the terminals of the individual two twisted wire pairs, in embodiments, the distance from one twisted wire pair to each electric wire of the other twisted wire pair increases and noise can be reduced.

In a harness according to one embodiment, the terminals of the respective two twisted wire pairs are lined up in the same direction.

In embodiments, because the terminals of the two twisted wire pairs are lined up in the same direction, the electric wires of the two twisted wire pairs can be bent in the same positional relationship when the harness is bent outside the connector, and therefore, the harness can be easily routed.

The harness according to one embodiment includes an electric wire holding member having a groove with a curved shape for holding the electric wires of the twisted wire pairs.

In embodiments, because the electric wire holding member has a groove with a curved shape for holding the electric wires of the twisted wire pair, the electric wires of the twisted wire pair are prevented from spreading outside the connector and noise is reduced. Moreover, the harness can be guided so as to be curved outside the connector, and therefore, the harness can be easily routed.

### EFFECTS OF PREFERRED EMBODIMENTS

In embodiments, a harness including a twisted wire pair that can reduce noise and has an excellent assembly performance can be provided.

### BRIEF DESCRIPTION OF THE DRAWINGS

FIG. 1 is a schematic block diagram of a communication system using a harness according to embodiments.

FIG. 2 is a schematic outline view of the harness according to embodiments.

FIG. 3 is a cross-sectional side view of the connector in FIG. 2.

FIG. 4 is a perspective view of a portion in which the twisted wire pairs are connected to the connector.

FIG. 5 is a schematic view for illustrating a crosstalk occurring in an untwisted portion.

FIG. 6 is a perspective view of another example of a portion in which the twisted wire pairs are connected to the connector.

FIG. 7 is a perspective view of another example of a portion in which the twisted wire pairs are connected to the connector.

FIG. 8 is a perspective view of an end portion of the harness showing a state before an electric wire holding member is attached to the harness.

FIG. 9 is a perspective view of an end portion of the harness showing a procedure of attaching the electric wire holding member to the harness.

FIG. 10 is a perspective view of an end portion of the harness showing a state after the electric wire holding member is attached to the harness.

FIG. 11 is a diagram showing results of the study of a noise reduction effect by way of examples.

### DETAILED DESCRIPTION OF THE EMBODIMENTS

Hereinafter, embodiments of the present disclosure will be described based on the drawings.

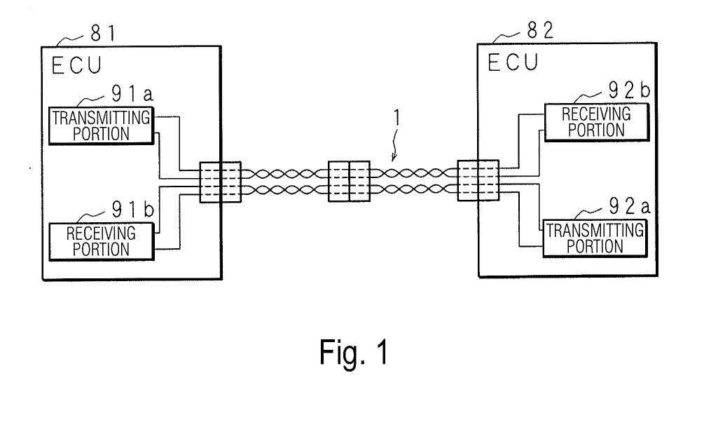

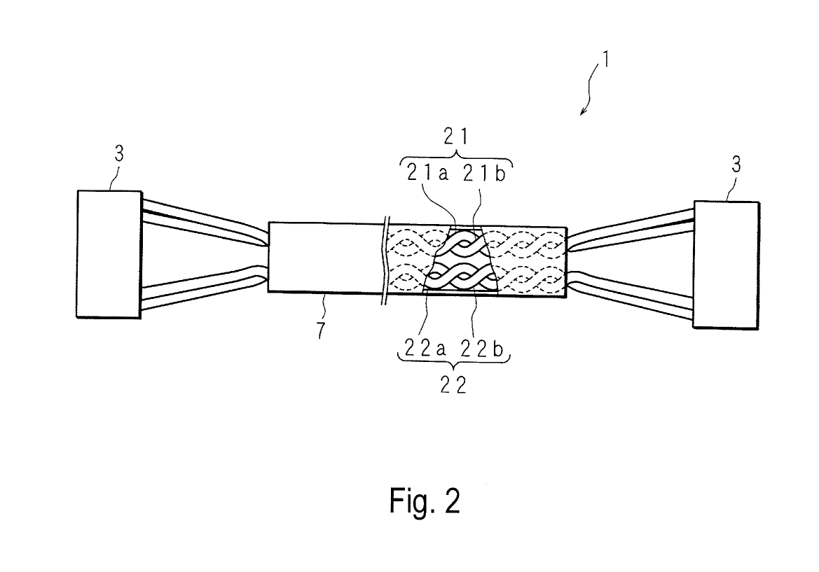

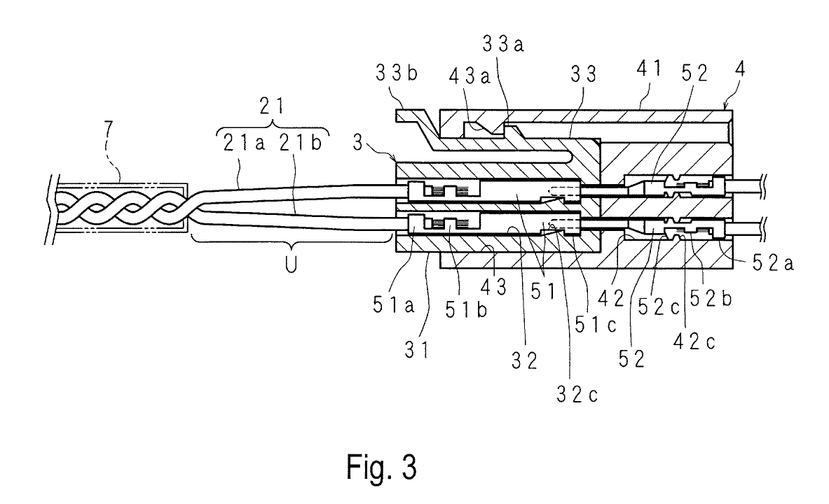

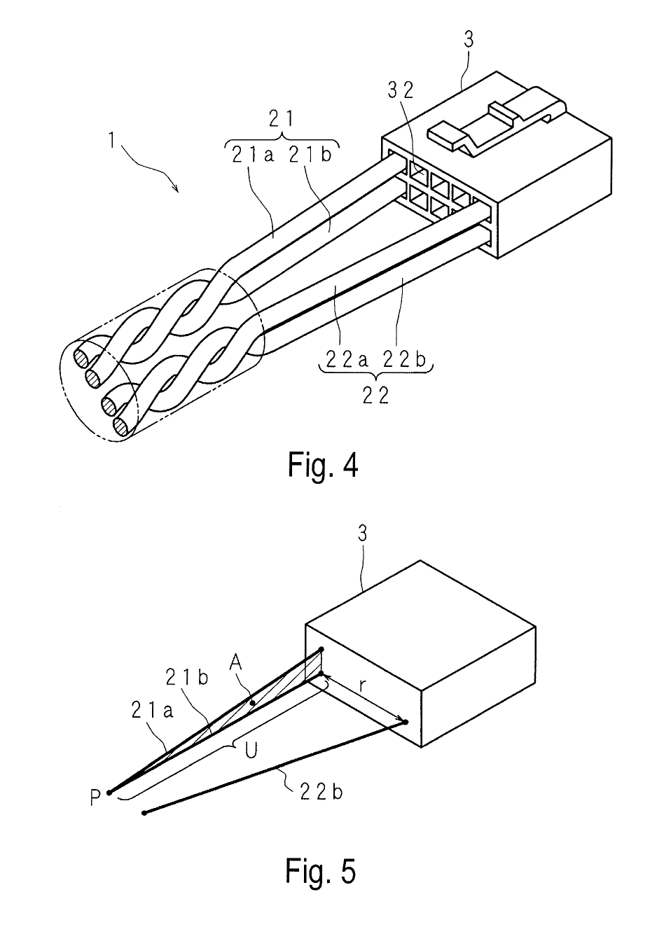

FIG. 1 is a schematic block diagram of a communication system using the harness according to embodiments, FIG. 2 is a schematic outline view of the harness according to embodiments, FIG. 3 is a cross-sectional side view of the connector in FIG. 2, and FIG. 4 is a perspective view of a portion in which the twisted wire pairs are connected to the connector. In FIG. 1, a communication system is formed by connecting between an ECU 81 and ECU 82 that are communication devices with a harness 1. The harness 1 connects a transmitting portion 91a and a receiving portion 91b that are included in the ECU 81 to a receiving portion 92b and a transmitting portion 92a that are included in the ECU 82, respectively. The transmitting portions 91a and 92a transmit signals in accordance with a communication protocol such as Ethernet (registered trademark) and MOST (Media Oriented Systems Transport) to the receiving portions 92b and 91b, respectively, via the harness 1.

In embodiments, ECUs may be connected with one harness 1 or a plurality of the harnesses 1 with a relay connector being provided between the harnesses 1. In both cases, as shown in FIG. 2, the harness 1 includes at least two twisted wire pairs 21 and 22, connectors 3 attached to both ends of the twisted wire pair, and a covering material 7. The covering material 7, which is a tubular member made of resin, cloth or the like, covers the twisted wire pairs 21 and 22 and protects them from the external environment. The harness 1 may also have other signal wires and power wires (not shown) besides the two twisted wire pairs 21 and 22.

The twisted wire pair 21 includes electric wires 21a and 21b that are twisted together, and the twisted wire pair 22 includes electric wires 22a and 22b that are twisted together. In the twisted wire pair 21, the electric wires 21a and 21b are spirally twisted together, and therefore, noise currents that are generated in the electric wires 21a and 21b by electromagnetic waves from the outside flow adjacently in the twist in opposite directions and offset each other. Therefore, the external electromagnetic waves are not likely to affect the twisted wire pair 21. This is the same in the twisted wire pair 22.

Moreover, the twisted wire pairs 21 and 22 have different twist pitches in order to reduce crosstalk noise between the twisted wire pairs 21 and 22. For example, crosstalk noise received from the electric wires 21a and 21b of the twisted wire pair 21 by the electric wire 22a is reduced due to the different twist pitches.

Specifically, in embodiments, the electric wires of the twisted wire pair 21 that come close to the electric wire 22a at different locations in a longitudinal direction are the electric wire 21a and the electric wire 21b, due to the different twist pitches. Differential signals may be transmitted in the electric wires 21a and 21b and the currents may flow in different directions, and therefore, in embodiments, the noises caused by the electric wires 21a and 21b cancel each other over the entire length of the electric wire 22a and the crosstalk noise is reduced.

As shown in FIG. 3, a connector 3 includes a housing 31 and an elastic piece 33, for example. In embodiments, the connector 3 fits to a connector 4, so that a first terminal 51 connected to the connector 3 is connected to a second terminal 52 connected to the connector 4. FIG. 3 shows a case where the first terminal 51 is a socket (terminal) and the connector 3 is a connector on the socket side, but the connector 3 may be a connector on a pin side (e.g., the connector 4 shown in FIG. 3) that houses a pin (terminal). Moreover, a mating connector to which the connector 3 provided at the end portion of the harness 1 is connected may be a connector of the end portion of another harness or a connector portion provided in the housing of the ECU 81 or 82.

As shown in FIG. 4, in embodiments, the housing 31 includes terminal housing chambers 32 arranged in two rows and five columns. The terminal chamber 32 is a partitioned space having an elongated rectangular shape, and has an opening into which the first terminal 51 is inserted on one side and an opening into which the tip of the second terminal 52 is inserted on the other side. The terminal housing chamber 32 is provided with a locking projection 32c for locking the first terminal 51. The elastic piece 33 is formed so as to rise from one end of the housing 31 and extend to the other side. The elastic piece 33 is provided with a locking projection 33a for locking the connector 3 to the connector 4. Moreover, a lever portion 33b separating from the housing 31 is formed on the tip of the elastic piece 33 in order to push down the elastic piece 33.

In embodiments, the connector 4 to which the connector 3 fits includes a housing 41. The housing 41 may include terminal housing chambers 42 arranged in two rows and five columns in the same manner as in the connector 3. The terminal housing chamber 42 may be a partitioned space having an elongated rectangular shape, and may have an opening into which the second terminal 52 is inserted on one side and an opening from which the tip of the second terminal 52 projects on the other side. In embodiments, the terminal housing chamber 42 is provided with a locking projection 42c for locking the second terminal 52. Moreover, the housing 41 may have a connector fitting portion 43 to which the connector 3 fits. The connector fitting portion 43 may be formed by the inner wall along the outline of the connector 3. The connector fitting portion 43 may be provided with a locking projection 43a to be engaged by the elastic piece 33 of the connector 3.

The first terminal 51 connected to the connector 3, in embodiments, has a crimping portion 51a that fixes the end portions of the electric wires 21a and 21b of the twisted wire pair 21 together with the cover, a crimping portion 51b that electrically connects and fixes a core wire, and a locking portion 51c that engages the locking projection 32c of the connector 3. The second terminal 52 connected to the connector 4 may have a crimping portion 52a that fixes the end portion of the electric wire together with the cover, a crimping portion 52b that electrically connects and fixes a core wire, and a locking portion 52c that engages the locking projection 42c of the connector 4.

In embodiments, the first terminal 51 is inserted to the terminal housing chamber 32 of the connector 3 and the locking portion 51c is engaged with the locking projection 32c. Moreover, by inserting the second terminal 52 to the terminal housing chamber 42 of the connector 4 and engaging the locking portion 52c with the locking projection 42c, the tip portion of the second terminal 52 may project to the connector fitting portion 43. By fitting the connector 3 to the connector fitting portion 43 of the connector 4 and engaging the locking projection 33a with the locking projection 43a, the connector 3 may be connected to the connector 4 and the tip of the second terminal 52 may fit to the tip of the first terminal 51 to be electrically connected.

When inserting the first terminal 51 to the terminal housing chamber 32 of the connector 3, although an assembly method in which a plurality of the first terminals 51 are inserted to the connector 3 one by one facilitates the work and provides an excellent assembly performance, as shown in FIG. 3, an untwisted portion U in which the electric wires are untwisted to loosen the twist is necessary when one first terminal 51 (e.g., the terminal of the electric wire 21a) is inserted to and connected to the connector 3 and then, next first terminal 51 (e.g., the terminal of the electric wire 21b) is inserted to the connector 3. If there were no untwisted portion U, then the assembly work would have to be performed by inserting all the first terminals 51 to the connector 3 at the same time, and therefore, the workability would be remarkably deteriorated. Furthermore, in a work of removing the first terminals 51, all the first terminals 51 would have to be removed from the connector 3 at the same time, and therefore, the removing work would be very difficult.

Accordingly, it is preferable that the harness 1 according to embodiments is provided with the untwisted portion U in order that the harness 1 can be easily assembled, and the electric wires and terminals are arranged in the untwisted portion U in a manner that reduces the crosstalk noise that occurs in the untwisted portion U. The connector 3 shown in FIG. 4 is a ten way connector that has two rows in each of which five terminal housing chambers 52 is provided. The first terminals 51 may be connected to the connector 3 so as to enlarge the spacing between the two first terminals 51 crimped to the end portions of the electric wires 21a and 21b of the twisted wire pair 21 and the two first terminals 51 crimped to the end portions of the electric wires 22a and 22b of the twisted wire pair 22. Specifically, in embodiments, the electric wires 21a and 21b are connected to the upper and the lower terminal housing chambers 32 on one outer side of the connector 3, and the electric wires 22a and 22b are connected to the upper and the lower terminal housing chambers 32 on the other outer side of the connector 3 to be arranged such that the spacing between neighboring terminals among the twisted wire pairs 21 and 22 is larger than the spacing between the terminals of the individual twisted wire pairs 21 and 22.

FIG. 5 is a schematic view for illustrating a crosstalk occurring in the untwisted portion U. FIG. 5 indicates the center lines of the electric wires 21a, 21b and 22b that are connected to the connector 3 by solid lines. To illustrate the crosstalk, the center lines of the electric wire 21a and 21b, which do not intersect actually, are assumed to intersect at the starting point P of the untwisted portion U on the assumption that the crosstalk in the twisted portion is very small.

In embodiments, the electric wire 22b receives the crosstalk noise N from the electric wires 21a and 21b in the untwisted portion U. The crosstalk N is expressed approximately by the following equation;

N=C×(A/r)×I

where r is the distance between the electric wire 21b and the electric wire 22b, A is the area of the region surrounded by the electric wires 21a and 21b, I is the current in the electric wires 21a and 21b, and C is the proportional constant.

Accordingly, in embodiments, the crosstalk noise N can be reduced by reducing the area A or increasing the distance r. The spacing between the terminals of the electric wires 21a and 21b may be reduced to reduce the area A, and the distance between the electric wires 21b and 22b may be increased to increase the distance r. That is, the electric wires are arranged such that the spacing between neighboring terminals among the twisted wire pairs 21 and 22 is larger than the spacing between the terminals of the individual twisted wire pairs 21 and 22, so that the crosstalk noise can be reduced.

As described above, in the harness that includes the connector 3 and the two twisted wire pairs 21 and 22 in which the first terminals 51 are crimped to the end portions and is formed by connecting the first terminals 51 to the connector 3, the spacing between neighboring terminals among the two twisted wire pairs 21 and 22 is larger than the spacing between the terminals of the individual two twisted wire pairs 21 and 22, so that the crosstalk can be reduced. Furthermore, since the harness has the untwisted portion U in which the electric wires are untwisted from the end portions of the two twisted wire pairs 21 and 22 to loosen the twists outside the connector 3, the assembly work of connecting the electric wires of the twisted wire pairs 21 and 22 to the connector 3 with the first terminals 51 crimped to the end portions thereof is improved.

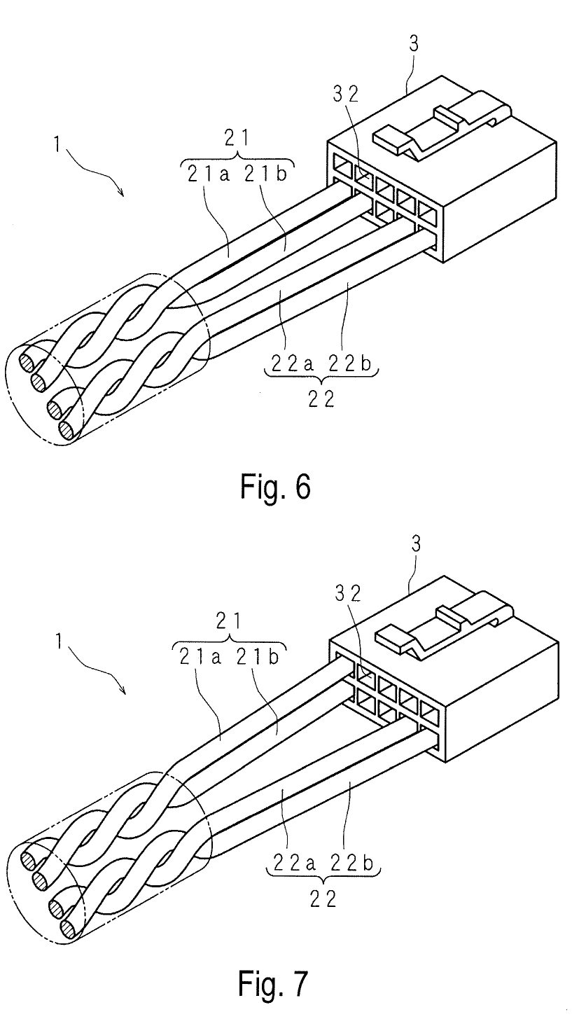

FIG. 6 is a perspective view of another example of a portion in which the twisted wire pairs are connected to the connector. The example shown in FIG. 6 connects the electric wires 21a and 21b and the electric wires 22a and 22b to the terminal housing chambers 32 in the lower row except the central terminal housing chamber 32. Thereby, the electric wires can be arranged such that the spacing between neighboring terminals among the twisted wire pairs 21 and 22 (between the terminals of the electric wires 21b and 22a in FIG. 6) is larger than the spacing between the terminals of the individual twisted wire pairs 21 and 22.

Moreover, FIG. 7 is a perspective view of another example of a portion in which the twisted wire pairs are connected to the connector. The example shown in FIG. 7 connects the electric wires 21a and 21b to the upper and the lower terminal housing chambers 32 on an outer side of the connector 3. The electric wires 22a and 22b are gathered to the opposite side from the side on which the electric wires 21a and 21b are connected and are connected to the terminal housing chambers 32 in the lower row of the connector 3. Thereby, the electric wires can be arranged such that the spacing between neighboring terminals among the twisted wire pairs 21 and 22 (between the terminals of the electric wires 21b and 22a in FIG. 7) is larger than the spacing between the terminals of the individual twisted wire pairs 21 and 22.

As shown in FIG. 4 and FIG. 6, in embodiments, the electric wires are connected to the connector such that the first terminals 51 of the two twisted wire pairs 21 and 22 are lined up in the same direction. Accordingly, when the harness 1 is bent outside the connector 3 and is routed, the electric wires of the respective two twisted wire pairs 21 and 22 are bent in the same positional relationship, and therefore, the harness can be easily routed.

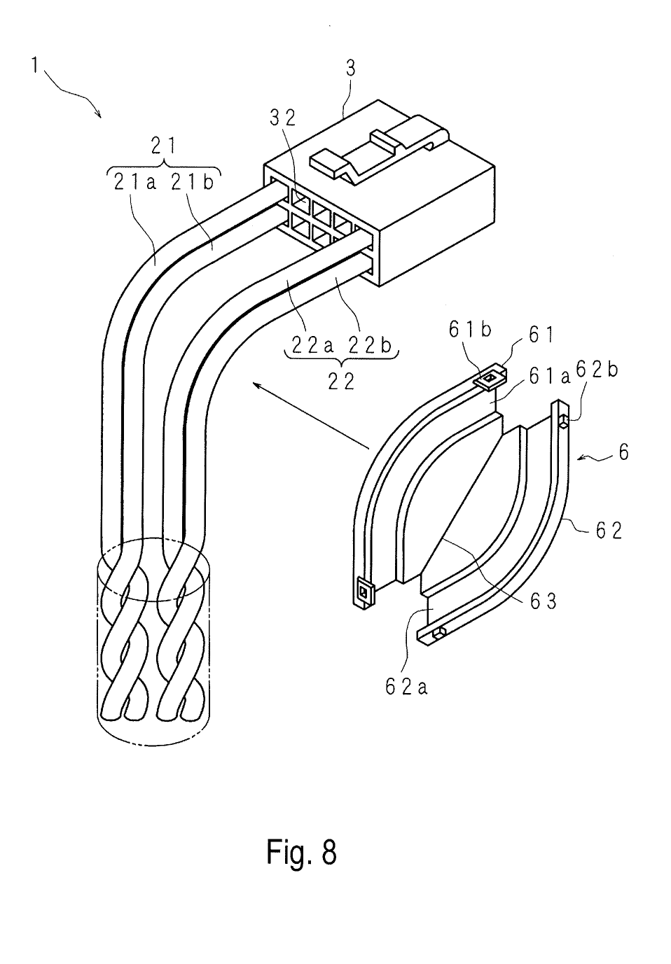

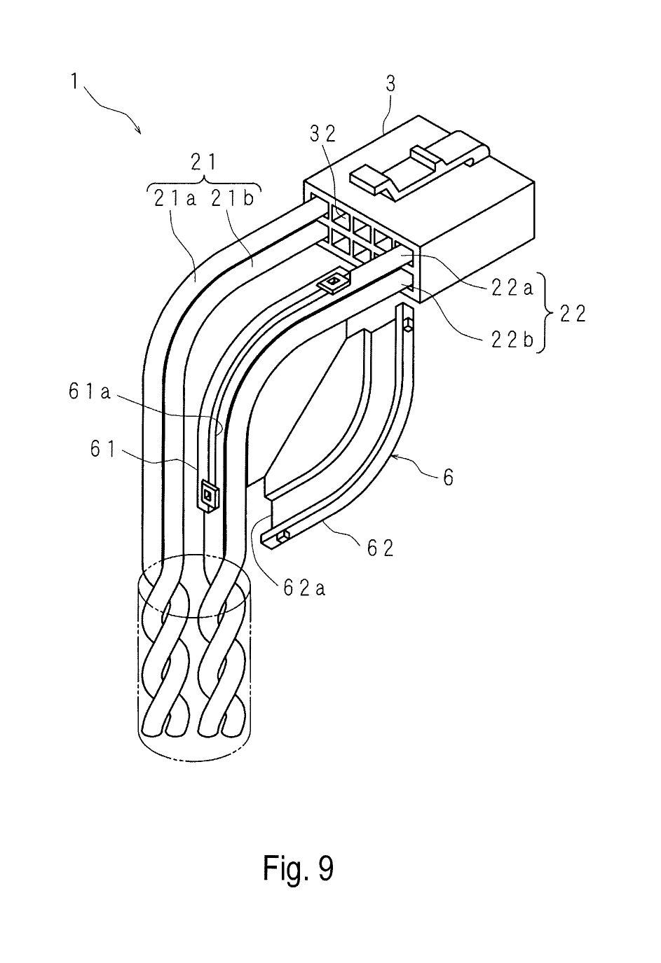

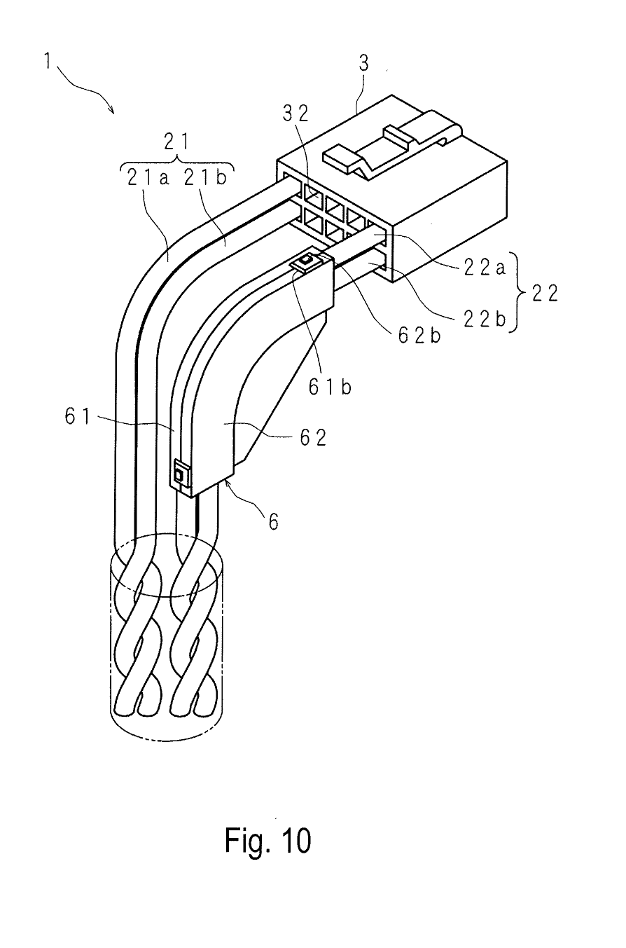

Moreover, when being bent outside the connector 3 and being routed, the harness 1 may have a configuration in which an electric wire holding member 6 is attached thereto so as not to change the positional relationship of the electric wires in the untwisted portion U. FIG. 8 is a perspective view of the end portion of the harness 1 showing a state before the electric wire holding member 6 is attached to the harness 1, FIG. 9 is a perspective view of the end portion of the harness 1 showing a procedure of attaching the electric wire holding member 6 to the harness 1, and FIG. 10 is a perspective view of the end portion of the harness 1 showing a state after the electric wire holding member is attached to the harness 1.

In embodiments, the electric wire holding member 6 includes half-split cases 61 and 62 that are formed of resin or metal materials and are coupled with a hinge portion 63. The cases 61 and 62 may have grooves 61a and 62a with a curved shape, respectively, on the split surfaces. Also, in embodiments, the case 61 has a locking portion 61b provided with a hole, and the case 62 has a locking projection 62b. As shown in FIG. 8, the case 61 is inserted from the underside of the electric wires 22a and 22b in a state where the case 61 and 62 is open, and, as shown in FIG. 9, the electric wires 22a and 22b are caused to come close to each other and are arranged along the groove 61a of the case 61. As shown in FIG. 10, by closing the case 61 and 62, the grooves 61a and 62a may be superposed to hold the electric wires 22a and 22b. The electric wire holding member 6 may also be attached to the electric wires 21a and 21b in the same manner. It should be noted that the locking projection 62b engages the hole provided in the locking portion 61b, so that a state where the cases 61 and 62 are closed is maintained.

Because, in embodiments, the electric wire holding member 6 uses the curved grooves 61a and 62a to hold the electric wires 22a and 22b and the electric wires 21a and 21b in a proximity state and arrange them along the curved grooves, the electric wires in the untwisted portions U of the respective two twisted wire pairs 21 and 22 are prevented from spreading and the crosstalk noise can be reduced. Moreover, the harness 1 can be guided so as to be curved outside the connector 3 and easily routed.

### EXAMPLES

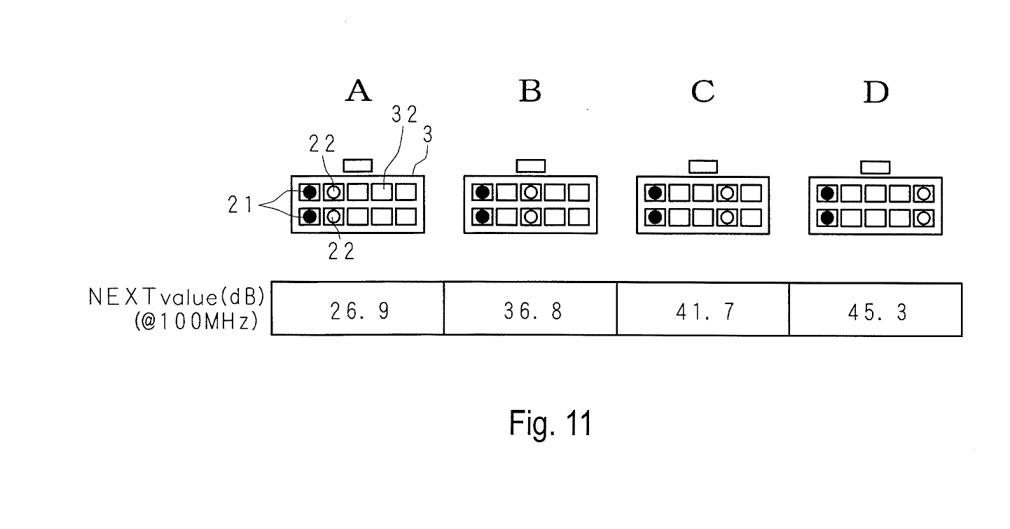

Examples of embodiments will now be described. FIG. 11 is a diagram showing results of the study of a noise reduction effect by way of examples. A 025 type ten way connector (the product number of a male connector: 6098-3869, the product number of a female connector: 6098-3909) of the TS connector series manufactured by Sumitomo Wiring Systems LTD. was used as the connector 3. There were four types of examples, which were a comparative example A and examples of present embodiments B to D. The spacing between the twisted wire pairs 21 and 22 was made larger in the order of the examples B to D by changing the terminal housing chambers 32 to which the twisted wire pairs 21 and 22 were connected. In order to study a noise reduction effect, NEXT values (maximum near end crosstalk loss) of signals at 100 MHz were obtained.

In FIG. 11, a black circle indicates the position to which the twisted wire pair 21 was connected, and a white circle indicates the position to which the twisted wire pair 22 was connected. NEXT values of the examples showed that the examples B to D exhibit a superior noise reduction effect to the comparative example A, and the noise reduction effect by the present embodiments was confirmed. Moreover, the NEXT specification value of signals at 100 MHz in a 100BASE-T (TIA-EIA-568-B.2) connector is 43 dB or more, and therefore, the NEXT value of 45.3 dB in the example D satisfies the specification value.

It should be noted that the embodiments disclosed above are to be understood as being in all ways exemplary and in no way limiting. The scope of the disclosure is defined not by the aforementioned descriptions but by the scope of the appended claims, and all changes that fall within the same essential spirit as the scope of the claims are intended to be included therein as well.

### LIST OF REFERENCE NUMERALS

1 Harness

21, 22 Twisted wire pair

21a, 21b, 22a, 22b Electric wire

3 Connector

51 First terminal (terminal)

52 Second terminal (terminal)

6 Electric wire holding member

1. A harness comprising a connector and two twisted wire pairs in which terminals for connection to the connector are crimped to end portions of the wires, the harness being formed by connecting the terminals to the connector,
wherein a spacing between neighboring terminals among the two twisted wire pairs is larger than a spacing between the terminals of the individual two twisted wire pairs.

2. The harness according to claim 1, wherein the terminals of the respective two twisted wire pairs are lined up in the same direction.

3. The harness according to claim 1, which includes an electric wire holding member having a groove with a curved shape for holding the electric wires of the twisted wire pairs.

4. The harness according to claim 2, which includes an electric wire holding member having a groove with a curved shape for holding the electric wires of the twisted wire pairs.
